(19) United States
(12) Patent Application Publication
(10) Pub. No.: US 2009/0300106 A1
(43) Pub. Date: Dec. 3, 2009

(54) MOBILE BOOK-MARKING AND TRANSACTION SYSTEM AND METHOD

(75) Inventors: Simon WOODSIDE, Waterloo (CA); Anton POLSKI, Waterloo (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: Semacode Corporation, Waterloo (CA)

(21) Appl. No.: 12/428,772

(22) Filed: Apr. 23, 2009

Related U.S. Application Data
(60) Provisional application No. 61/047,615, filed on Apr. 24, 2008.

(51) Int. Cl. G06F 15/16; G06K 7/10

(52) U.S. Cl. 709/203; 235/462.01; 709/206

(57) ABSTRACT

The invention is directed at a method, for use with a mobile device, of handling Internet-based links embedded within physical media. The method includes the steps of scanning a barcode which is embedded within a physical media with the mobile device whereby the barcode includes a Universal Resource Identifier (URI). After scanning the barcode, the barcode is decoded to determine an Internet Protocol (IP) address associated with the URI; and finally, the user is prompted with a set of options for accessing the URI.

### CROSS-REFERENCE TO RELATED APPLICATIONS

This application claims the benefit of priority of U.S. Provisional Patent Application No. 61/047,615 filed Apr. 24, 2008, which is incorporated herein by reference in its entirety.

### FIELD OF THE INVENTION

The present application relates generally to the field of mobile content delivery and retrieval, and in particular to systems and methods for book-marking, retrieving and processing content or transactions related to physical media or objects and conducting actions or transactions based thereon.

### BACKGROUND OF THE INVENTION

Presently, there is interest in easily and seamlessly connecting physical objects or physical media (i.e. magazines, newspapers, posters etc) to resources hosted on the Internet. A resource can be content, such as product information, product reviews, videos or other remote content, or transactional, such as product purchasing, movie ticketing, or other online transactions. For example, when a user is traveling, the user may not be able to access certain content on the Internet because they are unable to remember a hyperlink (e.g. uniform or universal resource locator (URL) or, more generally, a Universal Resource Identifier (URI) associated with some types of physical objects or physical media).

Some physical objects or media benefit from having an associated Internet resource or resources. For example, a user may read a magazine article and that article may have additional information and shopping options available on an associated Internet resource. If there was an easy way for the user to remember and access the associated Internet resource, the user may be more likely to access that Internet resource and purchase a related product.

Unfortunately, when a user comes in contact with physical objects or media, the user may have trouble accessing or remembering an associated Internet resource. As such, that user may be unable to follow through with their intention to visit the Internet resource, which could result in a negative outcome. For example: (A) a user might wish to purchase the product or an associated product online; (B) a user may want to participate in a branding experience, survey, prize giveaway, or other marketing activity related to the product; (C) a user may want to research the product online; (D) a user may want to share their interest in the product with their friends; (E) a user might want to record their interaction with the object for historical, follow-up, archival, tracking or diary purposes. If the user forgets a URI for the product, they might not purchase the product or perform other desired interactions. This may be a negative outcome for the user, as well as a negative outcome for the business selling the product.

Another situation is where the user comes in contact with physical objects or media, but their mobile device is unable to handle the associated Internet resource. For example, the image is larger than the small display on the mobile device, or the sound is in stereo and the mobile device only has mono sound output, or effective use of the resource requires input methods that the mobile device lacks, such as a keyboard.

In another situation, the interaction with the physical object or media represents the beginning of a transaction between the user and one or more third parties. For example, the user could initiate a process whereby they view a movie trailer, which is provided by a video service, have the opportunity to purchase a ticket, which is provided by a ticketing service or a movie theatre, participate in a promotional program, earn “points” towards future purchases, enter a contest, and inform their friends that they are viewing the film in the theatre.

In another situation, the user may come in contact with physical objects or media with an associated Internet resource, but be unable to interact with it due to a lack of available time.

Generally, the traditional notion of a hyperlink has been limited to the realm of electronic documents having textual string references to other documents. In this traditional context, users click textual hyperlinks to access electronic documents.

At present, there are known systems for scanning and decoding a barcode using a mobile device. In many cases, the barcode may be a two-dimensional (2D) barcode encoded with a URI. The mobile device may include software that utilizes optical decoding techniques to decode the barcode into a textual string representing a URI. Typically, the user is then taken to a website represented by the URI utilizing the browser on the mobile device.

### SUMMARY OF THE INVENTION

According to some of the embodiments described herein, there is a system and method to use barcodes to encode physical objects or media with hyperlinks to various Internet resources.

In an improved method, the mobile device reads the barcode, decodes the barcode to retrieve the encoded URI (while perhaps storing the barcode or related URI on the mobile device), and transmits the URI to a server via a wireless network. The software on the mobile device may parse the URI and provide options to the user based on the URI, such as, for example, save URI for future use, view related URI on browser, or commence a transaction, or the like. Alternatively, the URI could be parsed by the server and the server can then provide the options to the user of the mobile device via the network.

As such, this method provides enhanced computer communications, mobile content delivery, Internet access, and online transaction services. By attaching barcodes to physical media the method can provide a new way to direct users to Internet content and/or transactions related to an initial physical object, such as everyday physical items such as manufactured objects, printed media and geographical locations.

### BRIEF DESCRIPTION OF THE DRAWINGS

Example embodiments of a system and method for mobile book-marking is shown in the attached figures.

FIG. 1 is a schematic diagram of a bookmarking service model;

FIG. 2 illustrates a platform for handling Universal Resource Identifiers (URI) in a mobile environment;

FIG. 3 is a schematic diagram of a system for handling URIs in a mobile environment;

FIGS. 4 and 5 are schematic diagrams of examples of the system of FIG. 3 in use;

FIGS. 6 and 7 are flowcharts outlining a method of handling URIs in a mobile environment;

FIG. 8 is an illustrative example of a method of handling URIs in a mobile environment; and

FIG. 9 is an illustrative example of a method of menu service invocation.

### DETAILED DESCRIPTION OF THE DRAWINGS

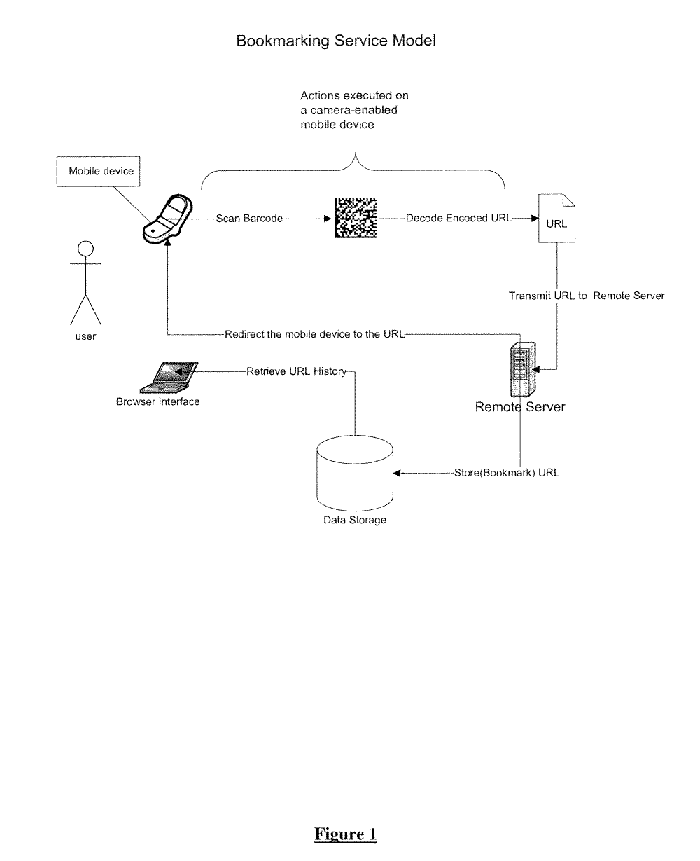

FIG. 1 illustrates a system and method in which a barcode is scanned to provide a URL (hyperlink) that can be used to provide a link to a website or the like and/or later used from a home PC to access the website or the like. This can be convenient for a user because they may wish to keep the URL available but may not wish to view it on the smaller screen of the mobile device. In a particular case, the remote server may link to the user's home PC to automatically create a bookmark for the URI so that the user has easy access to the URI. The remote server may be further configured to optionally provide the user with a reminder to view the URI. As will be understood by one of skill in the art, such a system and method can be implemented using software such as JAVA™, PERL, or other programming languages depending on the needs of the mobile device, PC, server or other computing device.

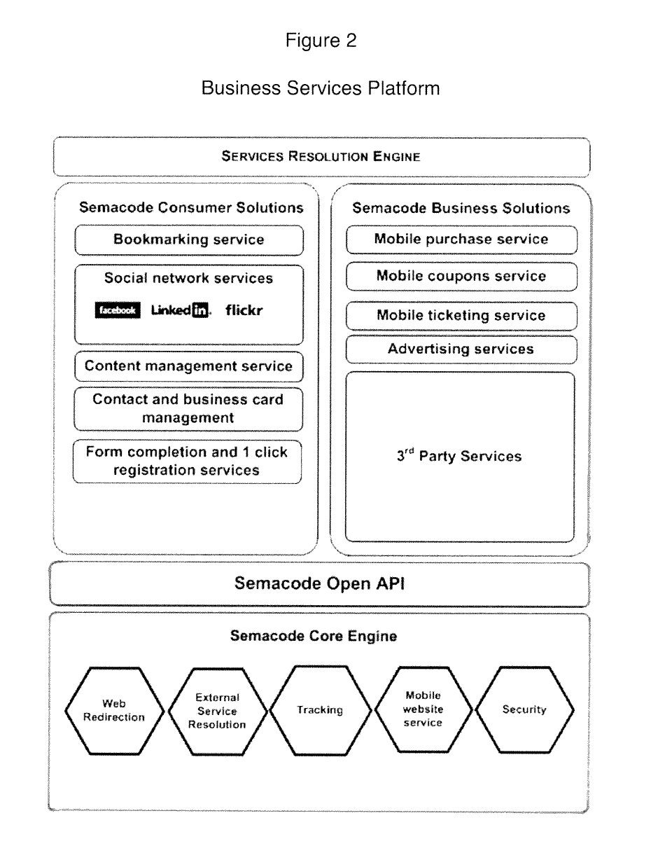

FIG. 2 illustrates a platform for handling URIs in a mobile environment. The platform includes modules for book-mark handling and transaction handling.

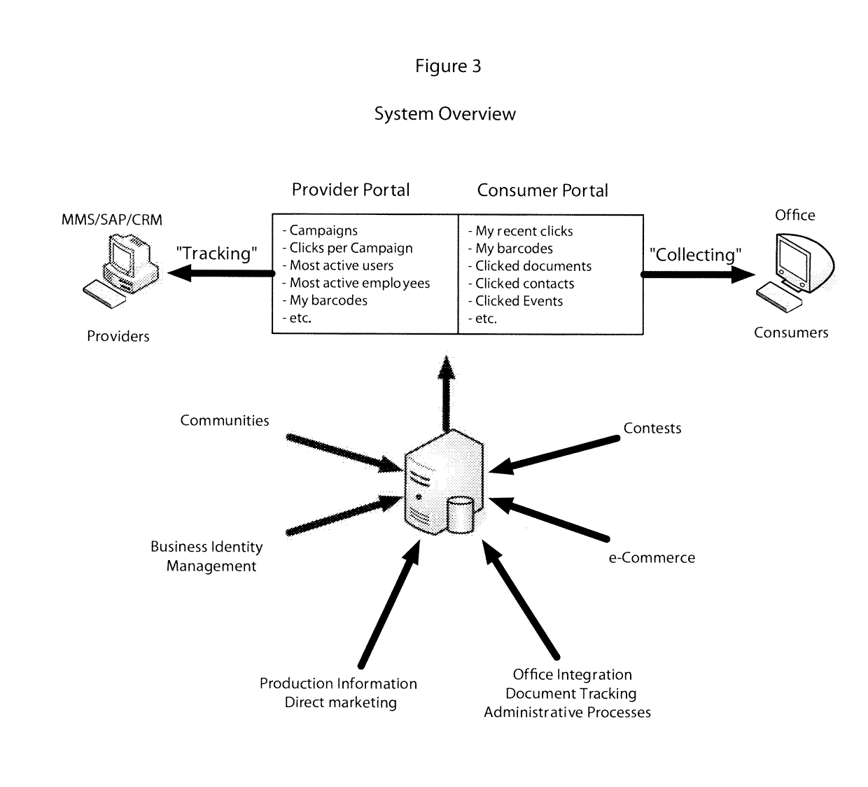

FIG. 3 illustrates an overview of a system that operates using the platform of FIG. 2. In this example system, a server provides a consumer portal that allows a user to access, manage and interact with the URIs that they have obtained using their mobile device and also provides a provider or business portal that allows companies to access data (preferably consolidated) with regard to activity with regard to access of URIs for their products/services.

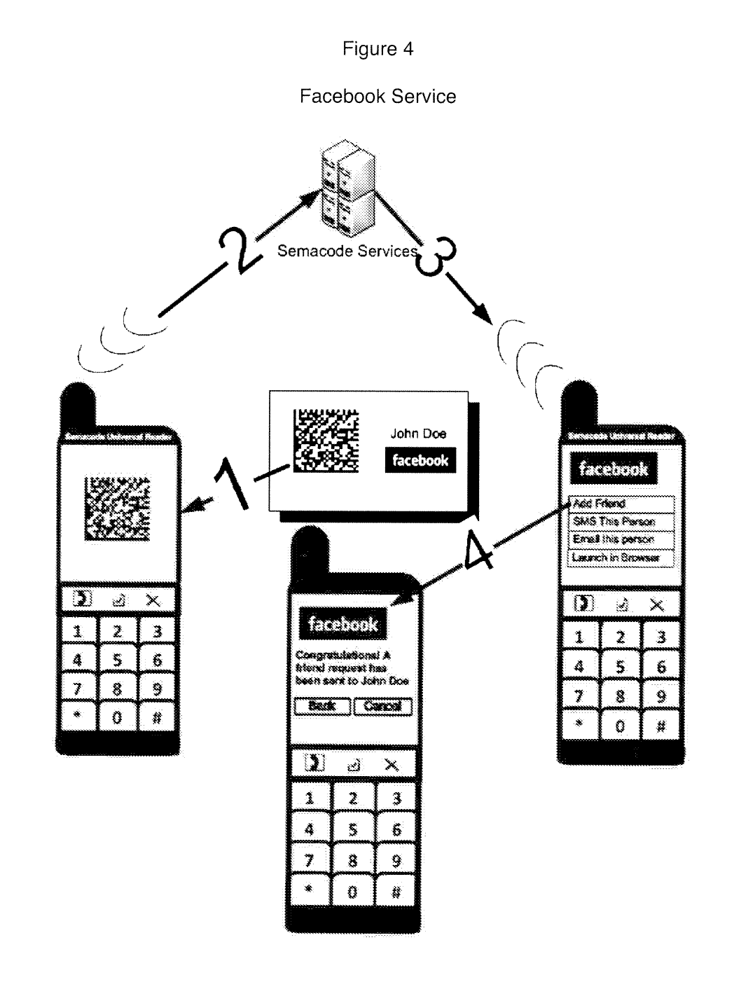

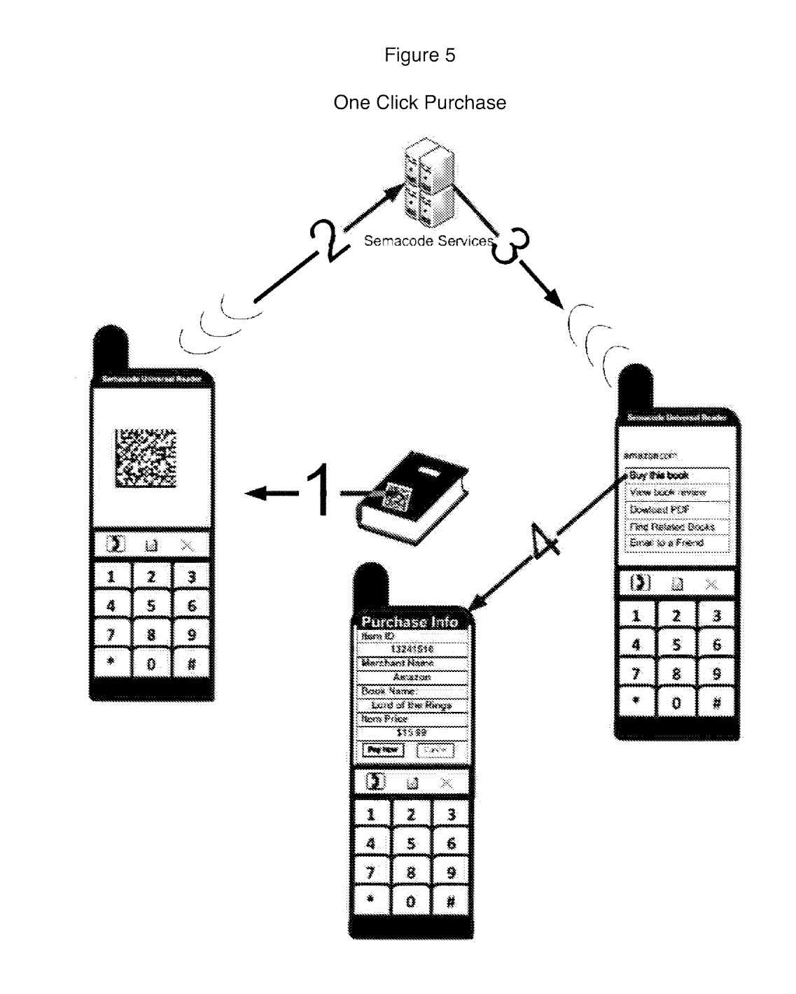

FIG. 4 and FIG. 5 illustrate two examples of the types of transactions/activities that may be conducted using the system and platform of FIGS. 2 and 3. In particular, on scanning a URI, a user is given various options on how to interact with or manage the URI and/or the transaction represented. As noted above, these options may be generated at the mobile device or may be received from a server, or may be some combination of the two.

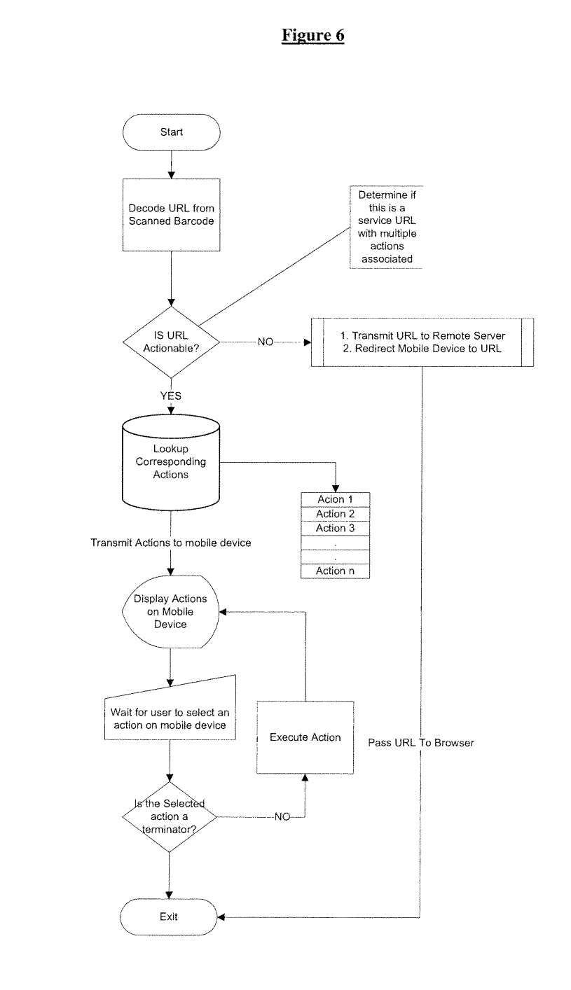

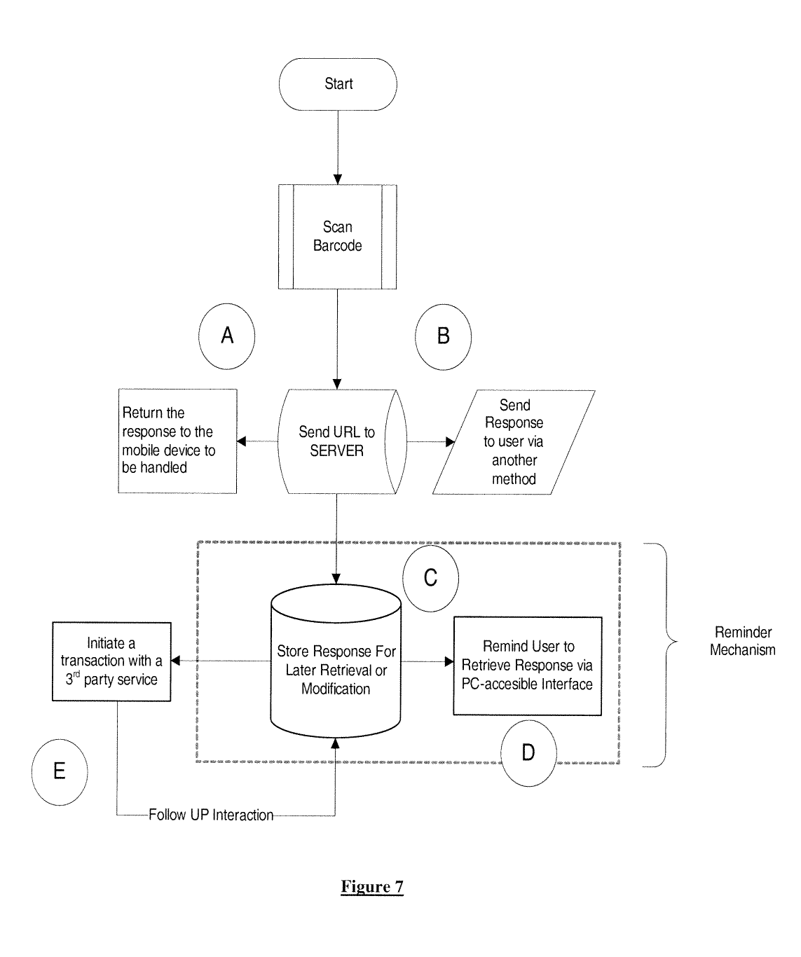

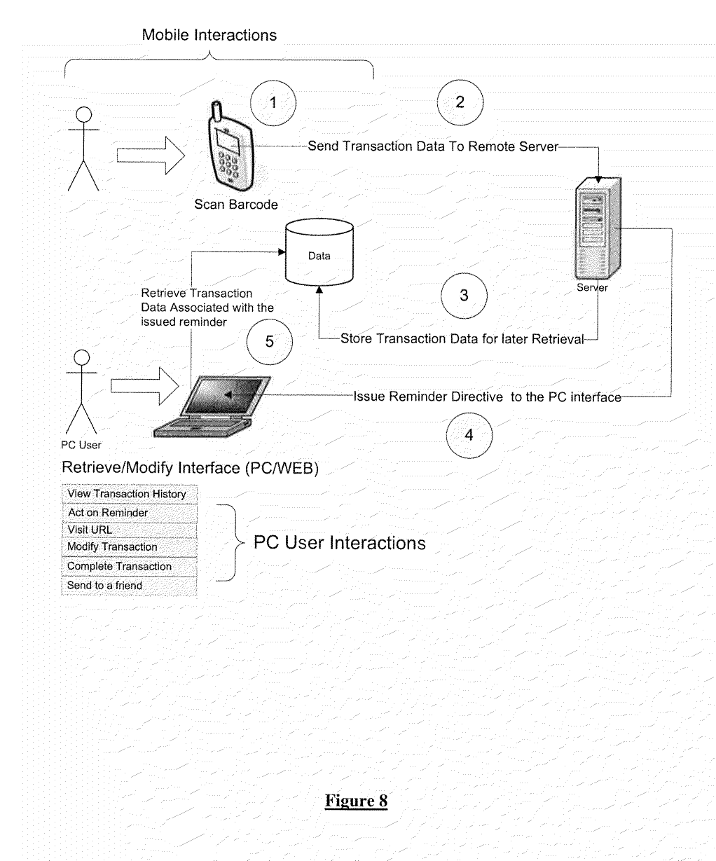

FIGS. 6-8 illustrate methods involving the handling of URIs that are scanned by a mobile device, including the option of initiating additional actions at the mobile device or at a later time.

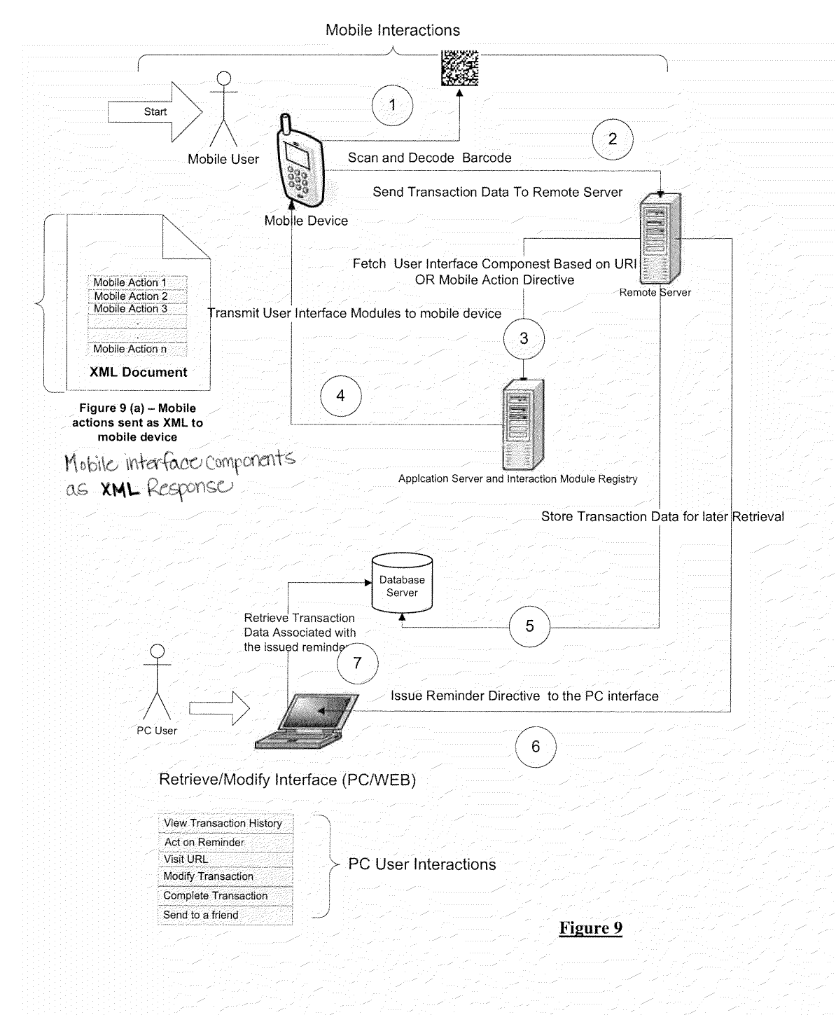

FIG. 9 illustrates the process of dynamically generating user interface components on the mobile device based on directives sent from the application server when a transaction has been initiated.

Some embodiments of the systems and methods described herein make reference to a mobile device. A mobile device is a two-way communication device with data communication capabilities having the capability to communicate with other computer systems. A mobile device may also include the capability for voice communications. Depending on the functionality provided by a mobile device, it may be referred to as a data messaging device, a two-way pager, a cellular telephone with data messaging capabilities, a wireless Internet appliance, or a data communication device (with or without telephony capabilities), a smart phone, or other terms. A mobile device communicates with other devices through a network of transceiver stations.

Some embodiments of the systems and methods described herein make reference to mobile software. Mobile software is a software program or application that is running on the operating system of the mobile device, such as Symbian, Android, etc., or on a platform SDK provided by the mobile device, such as iPhone SDK, Java Mobile Edition, etc. Depending on the provisions of the operating system or platform SDK, the mobile software may be able to access the mobile device's camera from within the application, may be able to display HTML content within the application or by sending the HTML to a separate browser on the device, display other types of information, interact with the user via keys or a touch screen, or have other capabilities.

According to an embodiment, there is a method that utilizes a barcode to simulate a hyperlink in a physical environment. Generally, a barcode is a machine-readable representation of information in a visual format on a surface, such as the surface of physical objects or media. For example, the barcode may be a one-dimensional barcode (similar to a UPC), a matrix code (a 2D barcode), or other similar codes. Generally, a 2D barcode can store approximately 1 kilobyte of information. This storage capacity can be improved as known in the art.

Simulating a hyperlink in the physical environment can be achieved using the storage capacity of the barcode. In particular, a hyperlink or URI can be encoded within the barcode. A user then reads the barcode using a mobile device that includes a barcode reader. The barcode reader may be a barcode scanner, a digital camera, or another similar device as known in the art. After reading the barcode, the user accesses content associated with the URI, for example, via the mobile browser or the next time they have access to the Internet. Accordingly, the user can access a resource on the Internet that is associated with physical objects or media in a similar manner to clicking conventional electronic hyperlinks.

In some embodiments, the mobile device may allow direct access to the Internet. After storing a URI within the barcode, the user can access the associated electronic content, resource, or transaction directly on the mobile device.

In some embodiments, the mobile device may analyze the URI stored within the barcode, and use logic on the mobile device to create a transaction or set of transactions that can be performed with a server. For example, from a single URI that leads to a Facebook™ user profile, the mobile device could create a transaction that allows the user to choose whether they want to add the user to their “friends”, message the user, or be reminded later about the user.

In another embodiment, the method can treat barcodes as computers sometimes treat hyperlinked web addresses. In traditional hyperlinked web address systems a user accesses an Internet resource by making an HTTP request based on a hyperlink in a web browser. In such web address systems the browser acts as a transmitter for transmitting a content request and for receiving requested content. Similarly, in one aspect, the method can treat the mobile device as a transmitter for content requests, such as document requests and requests for interactive sessions (e.g. online shopping).

In order to streamline the ability for a user to take advantage of the present method, all or most of the capabilities may be embodied in the form of a specific software program running on the mobile device. On some mobile devices these are called applications, or MIDlets (in Java), and generally they are accessible through a menu structure on the device, and can be downloaded and added to the device after the user acquires the device.

Furthermore, the mobile device may record other contextual data, such as user information, browsing habits, location where a barcode was scanned, and the type of physical object or media that was scanned. These contextual data can then be transmitted from the mobile device to a remote server. For example, the mobile device may transfer contextual data to a marketing analysis server that monitors the effectiveness of particular advertisements.

The remote server may be a single remote server, or a remote system which acts on the information transferred from the mobile device in order to determine an appropriate response, such as remote server which in turn communicates with other servers, systems, or people in the process of forming a response, or many servers which collectively perform such a function. The remote server may interact with one or more third-party servers or services, such as web services, in the process of generating a response.

According to another embodiment, the mobile device: reads a barcode having an encoded URI, decodes the barcode into a URI, performs a request to an Internet server that is associated with the URI. The remote server may then (A) return the response to the mobile device to be handled, possibly initiating an immediate interactive session on the mobile device, (B) hold the response for later retrieval by the user from the mobile device or on another Internet-based user interface, (C) hold the response and remind the user to continue with retrieval at a later time, (D) send the response to the user via another method such as email, or (E) initiate a transaction with one or more third parties which could have a number of outcomes over time, including the above outcomes, and especially including follow-up interactions between the user and the third parties

In the case where the remote server initiates an interactive session, the remote server can construct a set of instructions for the mobile device to follow in order to present the interactive session information to the user. For example, the remote server may construct HTML, which the mobile device may present in a browser, or the remote server might construct the information in a format specifically intended to be understood by the mobile device or special software running on the mobile device.

Accordingly, the remote server can record historical and/or follow-up data related to a transaction related to the requested URI. For example, the data may include the requested URI, the response returned, and contextual data such as a user ID, a time of request, or a location from which the request was made. In particular, the remote server stores at least some of the data associated with the transaction. The remote server may also store other data elements, for example in the form of text. Upon receiving the transaction request, the remote server stores the data, which the user or other parties or systems may access and act on at a later time.

Since the remote server stores historical/follow-up data, the stored data can be made available for access via an Internet-Based interface. For example, the user can access an Internet address associated with a stored transaction in the form of a hyperlink on a provided web page. The user may access the information from a mobile device, a home computer, or another computing device. In another example, a marketing organization could access the stored data of a particular user or statistics compiled from the stored data of many users, in order to improve the effectiveness of their marketing efforts. Also, marketing experts of computer software could use the stored data to automatically improve the effectiveness of the responses made to transaction requests by the users of the system. In another example, a third party system could access the stored data in order to initiate a follow-up transaction, such as inviting the user to participate in a contest, providing the user with additional offers, etc.

In the case that the user accesses a stored record, the user can then retrieve the stored or bookmarked hyperlink at a later time from the remote server, for example using a web interface on a PC. Accordingly, the user can choose to navigate directly to the resource using the mobile device, or the user can retrieve the hyperlink later on the mobile device, or on another Internet-based user interface, via the centralized interface.

In the case that the stored data represents or could represent a transaction or the beginning of a transaction (a transaction-initiating URI), the user can then retrieve the transaction information at a later time from the remote server, for example using their mobile phone or a web interface on a PC. Accordingly, the user can perform follow-up actions as defined by the user or a third party related to the transaction. For example, the user can respond to an offer to participate in a contest, or request discounted products or services, the option of watching or resuming watching a video, or the like.

Over time there may be many types of possible transactions, and the types of transactions might change or increase, and it is preferred that the software running on the mobile device can automatically support new or changed transactions at any time without the base software itself needing to be updated or changed. In order to accommodate this, all of the information regarding a particular category of transactions may be encapsulated into a data module that defines information for the mobile software and the server software, on what transactions are possible, how to process them, how to display them to the user, and what options the user should have related to the transaction. For example, all of the transactions related to shopping at a particular store might comprise one module, which defines transactions related to purchasing, checking store inventory, and making store appointments, how to communicate with the server belonging to the store, and how to display these options to the user both on their mobile device and on other devices such as their personal computer.

In addition to allowing the user to interact with the remote server, the user interface displayed to the user on the mobile device may also enable the user to interact with functions that are native to the mobile device, such as initiating a photograph with the built-in camera, making a phone call, etc.

In order make the system more flexible to changes and adaptable to new applications, the system can include three tiers: the mobile client interface, the remote server that acts primarily as a dispatch server, and many application servers. The dispatch server directs information between the mobile device and the appropriate application server for a particular set of barcode URIs or types of barcode, while the application server is responsible for processing the information received from the mobile device and determining the response. The response then passes through the dispatch server back to the mobile device. As shown in FIG. 9 the URL is passed on by the dispatch server to the application server which in turn generates the necessary instructions for the mobile device to allow the user to interact with the service. The application server can be updated at any time in order to change the complete logic for any given URI.

In the case that the system is intended to remind the user to continue to interact with the resource, the remote server may indicate to the user that there is a pending transaction the next time that the user connects to the server, or by messaging the user using methods such as email, wireless text messaging, instant messaging, or other electronic messaging methods.

In the present system and method the URI, optionally including elements of transactional data, is typically stored inside the barcode. Thus, a separate database that links barcode information to URIs is not necessarily required. The transaction data elements may then be interpreted by an application server to determine the protocol handler to be used. Each type of transaction category or service may have a handler associated the function of which is to fetch the user interaction directives and pass them on to the dispatch server to be delivered to the mobile device. Second, the present system and method operates so that a transaction may pass through a remote server. In such a case, the remote server can act as a data dispatch to mobile devices such that the mobile devices operate as clients of the remote server. Furthermore, the user can use the remote server to access their stored data at a later time from either the same or a different device. Furthermore, the remote server provides the capability to continue transactions at a later time or be reminded to continue them.

An advantage of the invention is that the user can store the resource, or URI, and view or handle it later on a device with greater capabilities, such as a personal computer. Another advantage of the invention to the user and third parties is the provision of a system which can store and manage transactional details and moderate the interaction between the user and the third parties through various means, such as their mobile phone, personal computer, email, and a web site/internet server. Yet a further advantage is that if the user does not have enough time to interact with an Internet resource, the user can continue to access or interact with the resource at a later time. In addition it may be useful if there is a system to perform follow-up activities, such as to automatically remind the user to continue their interaction.

Accordingly, the methods and processes described above provide mobile device users with the ability to easily connect to, access, and transact with online media based on physical objects from a mobile device. In addition it provides users with the ability to save online transactions or activities and review and continue these activities later from their mobile device or other computing device. Using the methods and processes described herein, users may be more likely to access and interact with (visit and view) an Internet resource associated with physical media or objects.

What has been described is merely illustrative of the application of the principles of the embodiments. Other arrangements and methods can be implemented by those skilled in the art without departing from the spirit and scope of the embodiments described herein. It will be understood that the system and methods described herein or elements thereof may be implemented in software or hardware or a combination thereof. Software may include instructions that are recorded on a physical computer readable medium that may be executed by a computing device to perform the functions described.

What is claimed is:

1. For use with a mobile device, a method of handling Internet-based links embedded within physical media, the method comprising:
scanning a barcode, the barcode including a Universal Resource Identifier (URI);
decoding the barcode to determine an Internet Protocol (IP) address associated with the URI; and
prompting a user with a set of options for accessing the URI.

2. The method of claim 1 further comprising:
transmitting a content request to the IP address.

3. The method of claim 2 further comprising:
receiving an email associated with the content request.

4. The method of claim 1 further comprising:
storing the IP address within the mobile device as a bookmark.

5. The method of claim 1 wherein the IP address represents the address for a remote server.

6. The method of claim 1 wherein the set of options comprises save URI for future use, view related URI on a browser or commence a transaction.
